(19) United States
(12) Patent Application Publication
(10) Pub. No.: US 2025/0351049 A1
(43) Pub. Date: Nov. 13, 2025

(54) Wireless communication device with intelligent traffic control for multi-link operation and related method

(71) Applicant: MEDIATEK INC., Hsinchu City (TW)

(72) Inventors: Chun-Ting Lin, Hsinchu City (TW); Chung-Yu Tseng, Hsinchu City (TW); Wen-Yu Yang, Hsinchu City (TW); Yi-Cheng Huang, Hsinchu City (TW); Jen-Hung Hsiao, Hsinchu City (TW); Chun Chung, Hsinchu City (TW)

(73) Assignee: MEDIATEK INC., Hsinchu City (TW)

(21) Appl. No.: 19/194,011

(22) Filed: Apr. 30, 2025

Related U.S. Application Data
(60) Provisional application No. 63/645,202, filed on May 10, 2024.

(51) Int. Cl. H04W 40/16; H04W 52/02

(52) U.S. Cl. CPC H04W 40/16; H04W 52/0235

(57) ABSTRACT

A wireless communication device and a method for wireless communication that facilitate intelligent traffic control in a multi-link operation (MLO) mode are disclosed herein. The wireless communication device determines available communication links across different frequency bands and determines an aggregation limit for MAC Protocol Data Units (MPDUs) within a physical layer protocol data unit (PPDU) for each link. Links with smaller channel bandwidths are assigned smaller aggregation limits, and links with greater channel bandwidths are assigned larger aggregation limits. Subsequently, a link is selected, and data is transmitted to an access point through the selected link in a PPDU with a number of aggregated MPDUs that does not exceed the determined aggregation limit for that link.

### CROSS REFERENCE TO RELATED APPLICATIONS

This application claims the benefit of U.S. Provisional Application No. 63/645,202, filed on May 10, 2024. The content of the application is incorporated herein by reference.

### BACKGROUND

In past years, technology for local wireless communication has made great progress due to the development of the IEEE 802.11 standards. These standards define the protocols for local wireless communication systems to improve Wi-Fi abilities, which result in faster data speed, more reliable connection, and better user experience. Wi-Fi 7 (IEEE 802.11be) brings in a feature known as Multi-Link Operation (MLO), which enables a wireless communication device to communicate with an access point (AP) across multiple frequency bands, specifically the 2.4 GHz band, the 5 GHz band, and the 6 GHz band, simultaneously. The simultaneous multi-band communication provides an aggregated bandwidth, leading to better speed, stability, and overall network performance. However, handling the data flows over the multiple links presents significant challenges since each frequency band has its characteristics. For example, the 2.4 GHz band gives a longer range but less bandwidth, the 5 GHz band gives a balance of range and bandwidth, and the 6 GHz band gives the largest bandwidth but with a shorter range. Without intelligent data flow control, the data distribution across these links can become inefficient. Accordingly, available network resources may be underused, or certain links may be overloaded.

Due to the complexities of the Multi-Link Operation (MLO) in the Wi-Fi 7, traffic control cannot be properly managed by using simple methods like the random link selection or the traditional backoff mechanisms. These conventional approaches do not consider the inherent differences in the bandwidth, the range, and the interference sensitivity across the 2.4 GHz, 5 GHZ, and 6 GHz bands. For example, time-sensitive data may be sent over a busy or noisy link, and video streaming may be transmitted over a low-throughput channel. This lack of adaptability also means that these methods cannot effectively meet the specific demands of different applications. Applications like online gaming or video conferencing require low latency, while file transfers or video streaming require high throughput. Additionally, if the interference is not properly handled, the interference from sources like Bluetooth devices (which operate in the 2.4 GHz band) or Overlapping Basic Service Sets (OBSS) can seriously harm the performance of the wireless communication system.

### SUMMARY

An embodiment of the present invention provides a wireless communication device. The wireless communication device comprises at least one antenna and a processing circuit. The at least one antenna is configured to transmit and receive radio frequency signals. The processing circuit is coupled to the at least one antenna and configured to determine at least one available link between the wireless communication device and an access point across different frequency bands in a multi-link operation (MLO) mode. The processing circuit is further configured to determine, for each of the at least one available link, an aggregation limit representing a maximum number of MAC Protocol Data Units (MPDUs) that can be aggregated in a physical layer protocol data unit (PPDU) structure based on a channel bandwidth of each available link, such that an available link with a smaller channel bandwidth has a smaller aggregation limit, and an available link with a greater channel bandwidth has a larger aggregation limit. The processing circuit is further configured to select a link from the at least one available link and transmit data to the access point via the at least one antenna through the selected link by sending a PPDU having a number of aggregated MPDUs not exceeding the aggregation limit determined for the selected link.

An embodiment of the present invention provides a method for wireless communication. The method comprises determining, by a wireless communication device, at least one available link between the wireless communication device and an access point across different frequency bands in a multi-link operation (MLO) mode; determining, by the wireless communication device, for each of the at least one available link, an aggregation limit representing a maximum number of MAC Protocol Data Units (MPDUs) that can be aggregated in a physical layer protocol data unit (PPDU) structure based on a channel bandwidth of each available link, such that an available link with a smaller channel bandwidth has a smaller aggregation limit, and an available link with a greater channel bandwidth has a greater aggregation limit; selecting, by the wireless communication device, a link from the at least one available link; and transmitting, by the wireless communication device, data to the access point via at least one antenna of the wireless communication device through the selected link by sending a PPDU having a number of aggregated MPDUs not exceeding the aggregation limit determined for the selected link.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a wireless communication system according to an embodiment of the present invention.

FIG. 2 is a flowchart of a method executed by the processing circuit of the wireless communication device shown in FIG. 1 according to an embodiment of the present invention.

FIG. 3 illustrates three PPDUs with different aggregation limits used in the wireless communication system shown in FIG. 1.

FIG. 4 is a flowchart of a method executed by the processing circuit of the wireless communication device shown in FIG. 1 when the wireless communication device operates in the enhanced Multi-Link Single Radio (eMLSR) mode.

FIG. 5 shows a flowchart of a method executed by the processing circuit of the wireless communication device shown in FIG. 1 when the wireless communication device operates in a coexistence environment.

### DETAILED DESCRIPTION

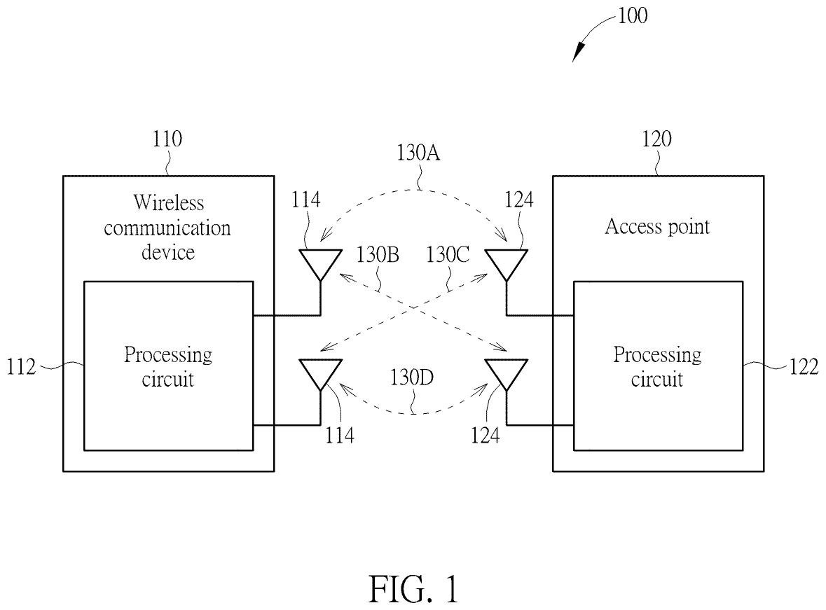

The current invention relates to a wireless communication device and a related method for improving data transmission efficiency of wireless networks, which conforms with the IEEE 802.11be standard (i.e., Wi-Fi 7). The present invention provides an upgraded intelligent traffic management system that is designed for Multi-Link Operation (MLO) mode, a feature of Wi-Fi 7 that supports simultaneous connection across various frequency bands, such as 2.4 GHz, 5 GHZ, and 6 GHz. It should be noted that although the frequency bands of the present invention are 2.4 GHz, 5 GHz, and 6 GHz as an example, the present invention can be applied to more different frequency bands according to needs and the future development of Wi-Fi. The accompanying images, particularly FIGS. 1 to 5, serve as visual tools to allow a full understanding of this invention for people skilled in the art of radio frequency communication.

Before starting the description of the present invention, in order to make it easier for those skilled in the art and those who are interested in the present technology to understand the present invention, the applicant first defines several terms in the Wi-Fi specification. These nouns include “band,” “channel,” “link,” “connection,” “band bandwidth,” and “channel bandwidth.”

A Wi-Fi band, as defined by IEEE 802.11 standards, refers to a specific range of radio frequencies allocated for Wi-Fi communication. Over the years, several frequency bands have been utilized for Wi-Fi, each with its own characteristics regarding range, data rate capabilities, and susceptibility to interference. Lower frequency bands, such as the 2.4 GHz band, generally offer a longer transmission range and better ability to penetrate obstacles like walls. Higher frequency bands, including the 5 GHz band and the more recently introduced 6 GHz band, support significantly higher data rates and offer a larger number of available non-overlapping channels. Besides these primary bands, other bands like 860/900 MHZ, 3.65 GHz, 4.9-5.0 GHZ, 5.9 GHZ, 45 GHz, and 60 GHz are also defined in the IEEE 802.11 standards for specific use cases or regions.

A Wi-Fi channel is a specific range of frequencies within a Wi-Fi band that is used for the actual transmission of data. These channels are subdivisions of the larger frequency bands, allowing multiple Wi-Fi networks or devices to operate in the same area without causing excessive interference, provided they utilize different, non-overlapping channels. Each channel has a certain width, known as the channel bandwidth, which determines the amount of data that can be transmitted over that channel.

A Wi-Fi link represents the physical radio connection established between two Wi-Fi-enabled devices, such as a client device (e.g., a laptop or smartphone) and a Wi-Fi access point (router). This connection occurs over a specific channel within a chosen frequency band and involves the transmission and reception of radio signals that are modulated according to the IEEE 802.11 physical layer specifications. The quality and performance of a Wi-Fi link, including its signal strength and achievable data rate, are influenced by various factors such as the selected band and channel, the distance between the devices, the presence of obstacles, and the level of interference from other wireless sources.

A Wi-Fi connection, in the context of network communication, is a logical association that is formed between a client device and a Wi-Fi network, typically managed by an access point. This process enables the client device to exchange data with other devices on the network or to access the internet. Establishing a Wi-Fi connection involves several steps, including scanning for available wireless networks (identified by their Service Set Identifier or SSID), authenticating with the network if it is secured (typically using a password), and associating with the access point. Once associated, the client device usually obtains an IP address, often through the Dynamic Host Configuration Protocol (DHCP), which allows it to communicate at the network layer. A Wi-Fi connection utilizes one or more underlying Wi-Fi links to facilitate this data transfer. In standard Wi-Fi operation, a connection typically relies on a single link established on a specific channel within a chosen band.

The establishment of a Wi-Fi link occurs when two devices, such as a client and an access point, mutually agree to communicate using a specific channel within a particular frequency band. The access point, acting as the central hub of a Wi-Fi network, typically broadcasts its presence and the frequency bands and channels it supports. When a client device scans for available networks, it detects these broadcasts and, based on user selection or pre-configured settings, attempts to establish a link with the desired network. This involves the client selecting a compatible frequency band (e.g., 2.4 GHz or 5 GHz) supported by both devices and then negotiating the use of a specific channel within that band for communication. Factors such as the capabilities of the devices, the network configuration set by the administrator, and the prevailing wireless environment, including potential interference from other networks or devices, can influence the selection of the band and channel for the link.

Multi-Link Operation (MLO) is a significant advancement introduced in newer IEEE 802.11 standards, most notably in 802.11be (Wi-Fi 7). This innovative feature allows a single device to simultaneously operate across multiple frequency bands (such as 2.4 GHz, 5 GHZ, and 6 GHz) and/or multiple channels within the same or different bands. Unlike previous Wi-Fi generations where a device typically connects to only one band at a time, MLO enables a device to establish and utilize multiple Wi-Fi links concurrently.

In standard Wi-Fi, a single Wi-Fi connection typically relies on a single Wi-Fi link operating on a specific channel within a chosen band. With MLO, a single Wi-Fi connection can now utilize multiple Wi-Fi links simultaneously. Each of these links still operates on a specific channel within a particular band, but the Wi-Fi connection is no longer bound to just one. Instead, the connection can aggregate the bandwidth provided by these multiple links, leading to significantly increased data throughput. Furthermore, using multiple links can provide redundancy, enhancing the reliability of the connection. If one link experiences interference or congestion, the connection can continue to operate using the other available links.

“Band bandwidth” refers to the total range of frequencies that are allocated to a specific Wi-Fi band. It represents the entire spectrum available for Wi-Fi operation within that particular frequency range. For example, the 2.4 GHz band typically spans from 2.400 GHz to 2.4835 GHZ, giving it a total bandwidth of approximately 83.5 MHz. The 5 GHz band has a much wider allocation, covering frequencies roughly from 5.150 GHz to 5.895 GHz, resulting in a total bandwidth of several hundred MHz (around 500+ MHz). The 6 GHz band offers the largest contiguous spectrum for unlicensed use, with a bandwidth of around 1200 MHZ (5.925 GHz to 7.125 GHz). The band bandwidth sets the upper limit on the total capacity available for Wi-Fi communication within that frequency range and dictates how many channels, and of what maximum width, can be accommodated.

“Channel bandwidth” refers to the width of a single Wi-Fi channel within a given band, typically measured in MHz. It represents the specific portion of the band's spectrum that a particular channel occupies and directly influences the amount of data that can be transmitted over that channel. Commonly used channel bandwidths in the 2.4 GHz band include 20 MHz and 40 MHz. Commonly used channel bandwidths in the 5 GHz band include 20 MHz, 40 MHz, 80 MHZ, and 160 MHz. Commonly used channel bandwidths in the 6 GHz band include 20 MHz, 40 MHZ, 80 MHZ, 160 MHz, and 320 MHz. A wider channel bandwidth provides more subcarriers for data transmission, leading to higher potential data rates.

Please refer to FIG. 1. FIG. 1 is a functional block diagram of a wireless communication system 100 according to an embodiment of the present invention. The wireless communication system 100 is compatible with the Wi-Fi 7 (IEEE 802.11be) standard and comprises a wireless communication device 110 and an access point (AP) 120. The wireless communication device 110 can establish communication with the AP 120 via a plurality of links (e.g., 130A to 130D), operating on different frequency bands. For example, the link 130A may operate on the 2.4 GHz band, the link 130B may operate on the 5 GHz band, and the links 130C and 130D may operate on the 6 GHz band. Such configuration on different frequency bands allows the wireless communication device 110 to operate in the Multi-Link Operation (MLO) mode, as defined by the Wi-Fi 7 (IEEE 802.11be), so as to take advantage of the particular benefits of each band. It is important to note that the four links shown in FIG. 1 (130A to 130D) are only an illustrative example for the present invention. The actual number of active links between the wireless communication device 110 and the AP 120 can be dynamically adjusted and managed by the wireless communication device 110 based on several factors, such as the available frequency bands, the interference level, the application demands, and the capabilities of both the wireless communication device 110 and the AP 120. For example, the wireless communication device 110 may operate in an enhanced Multi-Link Single Radio (eMLSR) mode to use a single radio (i.e., only one set of RF transceiver hardware) that rapidly switches between different links operating on different frequency bands to simulate simultaneous multi-link communication. For another example, the wireless communication device 110 may operate in the MLO mode by simultaneously using the two antennas 114 thereof to communicate with the AP 120 across multiple frequency bands.

The wireless communication device 110 comprises a processing circuit 112 and at least one antenna 114 coupled to the processing circuit 112. In the embodiment, the wireless communication device 110 includes two antennas 114. In another embodiment, the wireless communication device 110 may have just one antenna 114 working in the eMLSR mode. In other embodiments of the present invention, the wireless communication device 110 may comprise three or more antennas 114. The processing circuit 112 manages the signal transmission and reception across the various bands via the antenna(s) 114. In the same way, the access point 120 has a processing circuit 122 and at least one antenna 124 to enable multi-band communication with the wireless communication device 110. This design takes advantage of the benefits of each frequency band: the 2.4 GHz band gives wide coverage, the 5 GHz band offers a balance of range and performance, and the 6 GHz band supplies high-speed data transfer. By intelligently managing these links (e.g., 130A to 130D), the wireless communication system 100 may provide reliable communication with adaptable throughput and latency for many different applications (e.g., real-time gaming, video streaming, etc.).

The processing circuit 112 may have a baseband processor for digital signal processing, such as modulation, demodulation, and error correction. The signal processing ensures that the radio signals transmitted and received across the links 130A to 130D via the antennas 114 are accurately encoded and decoded by the processing circuit 112. In addition, the processing circuit 112 may further include a media access controller (MAC) for handling aggregation of the MAC Protocol Data Units (MPDUs), link adaptation, and channel access. The baseband processor and media access controller of the processing circuit 112 may continuously monitor the performance of each link by evaluating the radio frequency (RF) metrics, including the signal strength (e.g., RSSI), the signal quality (e.g., SNR), and the interference from sources (such as OBSS, Bluetooth devices, and ambient noise). The antennas 114, connected to the processing circuit 112, help with the sending and receiving of the RF signals across the frequency bands, allowing data exchange with the access point 120. The processing circuit 122 of the AP 120 matches the abilities of its corresponding part in the wireless communication device 110. The processing circuit 122 may have a baseband processor for handling the incoming and outgoing signals across the links 130A to 130D. This involves functions such as signal modulation, demodulation, and error correction to keep data accurate. In addition, the processing circuit 122 may further comprise a MAC that oversees the protocol-level operations, including MPDU aggregation, link coordination, and channel access management. The processing circuit 122 connects with the antennas 124 to send and receive the RF signals while also responding to operational signals received from the wireless communication device 110, such as the Power Save Mode bit (PSB). The PSB indicates when a particular band is temporarily unavailable for the data reception, allowing the wireless communication device 110 to dynamically pause a specific link.

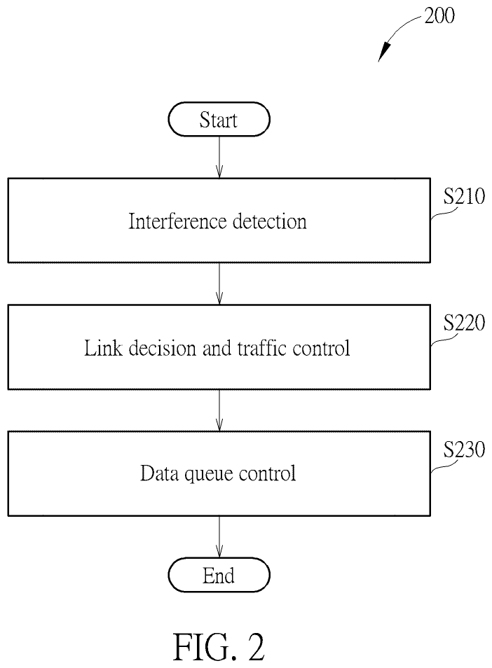

FIG. 2 is a flowchart of a method 200 executed by the processing circuit 112 of the wireless communication device 110 in FIG. 1 according to an embodiment of the present invention. The method 200 includes three steps for improving data transmission efficiency across several frequency bands by detecting interference, selecting available links based on performance indicators, and determining suitable data aggregation settings. The procedure ensures that the wireless communication device 110 could be adjusted dynamically for various network conditions.

In step S210, the processing circuit 112 determines the availability of links within the 2.4 GHz, 5 GHZ, and 6 GHz frequency bands. The determination is based on analyzing interference, such as Bluetooth activity, OBSS, and environmental noise. All of the interference can degrade the connection performance, particularly in the crowded 2.4 GHz band. In order to determine the available links, the processing circuit 112 may detect the interference in the Wi-Fi environment by using various methods, including analyzing Received Signal Strength Indicator (RSSI) and Signal-to-Noise Ratio (SNR), channel scanning, Clear Channel Assessment (CCA), error detection and correction, etc. For instance, the processing circuit 112 may measure each link's signal quality (e.g., SNR) and signal strength (e.g., RSSI). When the processing circuit 112 reports a low SNR but a very high RSSI, this is frequently a clear sign that there is a lot of interference. Further, the processing circuit 112 may perform channel scanning to identify available wireless links and potential sources of interference. In addition, the processing circuit 112 may use the Clear Channel Assessment (CCA) mechanism within the IEEE 802.11 standards to assess the availability and interference levels on multiple links in real-time, so as to determine the available links. Furthermore, the processing circuit 112 may use error detection methods like Cyclic Redundancy Check (CRC) to identify if data has been corrupted during transmission, which is often due to interference. The processing circuit 112 may also employ error correction methods like retransmissions and Forward Error Correction (FEC). A high rate of retransmissions often indicates a poor SNR caused by interference. Through the analysis in step S210, the processing circuit 112 may produce a real-time list of available links that can be used in steps S220 and S230.

In step S220, the processing circuit 112 assesses the performance of each available link to identify at least one selected link for data transmission. Step S220 focuses on two indicators: latency and throughput. Latency refers to the delay experienced by data packets (e.g., PPDUs) as they travel from the wireless communication device 110 to the AP 120. Throughput refers to the actual rate at which data is successfully transferred from the wireless communication device 110 to the AP 120. The processing circuit 112 determines the latency and throughput of each link by analyzing each link's channel bandwidth, current traffic loading, and historical performance. For example, a 2.4 GHz link affected by interference might offer higher latency and reduced throughput, making it less desirable. In contrast, a 6 GHz link with wide channel bandwidth and low congestion may provide low latency and high throughput, making it a good option for specific applications (e.g., video streaming). By meticulously assessing these properties, the processing circuit 112 selects at least one link from the available link(s) determined at step 210. Since the selected link satisfies the traffic's performance needs, a good combination of speed and reliability could be ensured.

In step S230, the processing circuit 112 determines an aggregation limit for MAC Protocol Data Units (MPDUs) within a Physical Layer Protocol Data Unit (PPDU) for each link that is determined available at step 220. The MPDU is the basic unit of transmission at the MAC layer and can be considered synonymous with an 802.11 frame. The 802.11 frame comprises three primary components: the MAC header, which contains addressing and control information vital for managing access to the wireless medium; the frame body, which carries the MSDU payload; and the frame check sequence (FCS) located in the trailer, used for error detection to ensure data integrity. The aggregation limit defines the maximum number of MPDUs that can be aggregated into a single PPDU. As defined by the IEEE 802.11 standard, a PPDU is the complete unit of data that the physical layer processes and transmits over the wireless medium. In networking, a PDU is the specific block of information exchanged at each layer of the protocol stack. The PPDU encapsulates data from the layer above it-the MAC (Medium Access Control) layer-and adds physical layer-specific information to enable wireless transmission. The PPDU in Wi-Fi is defined as the complete unit of data transmitted over the wireless medium, consisting of the physical layer headers, the encapsulated MAC layer data (MPDU), and any additional fields required for synchronization, signaling, and transmission at the physical layer. The processing circuit 112 can dynamically adjust the aggregation limit according to each link's channel bandwidth. Links with higher channel bandwidth, such as those in the 5 GHz or 6 GHz bands, are given greater aggregation limits. Since more MPDUs are allowed to be aggregated in a single PPDU, throughput can be increased and performance could be improved. In contrast, links with less channel bandwidth, such as those in the 2.4 GHz band, are assigned smaller aggregation limits to avoid prolonged airtime occupancy. The processing circuit 112 employs algorithms to determine these aggregation limits. Therefore, a link with a smaller channel bandwidth is restricted to a smaller number of aggregated MPDUs to reduce its airtime occupancy, thereby increasing the overall throughput of the wireless communication device 110 in the MLO mode. Once the processing circuit 112 determines an aggregation limit for each available link, these aggregation limits are applied during data transmission. Further, the wireless communication device 110 may set a Power Save Mode bit (PSB) to inform the AP 120 that a particular link is temporarily unavailable for the data reception, allowing the wireless communication device 110 to dynamically pause a specific link (e.g., a link having low throughput and long latency).

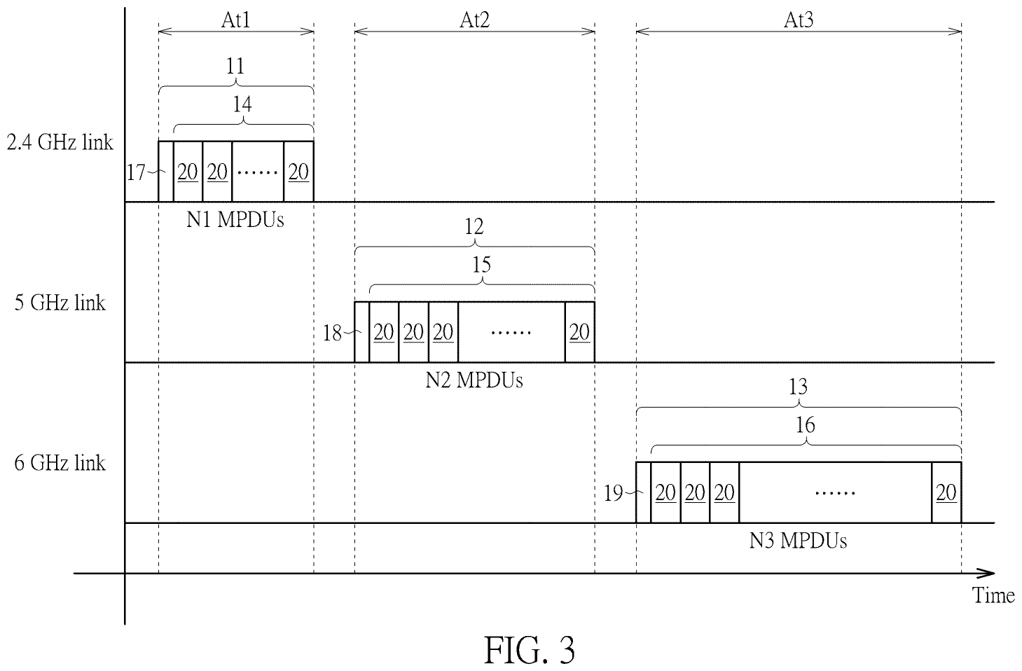

FIG. 3 illustrates three PPDUs 11, 12, and 13 used in the wireless communication system 100 shown in FIG. 1 when the wireless communication device 110 operates in the enhanced Multi-Link Single Radio (eMLSR) mode. Each of the PPDUs 11, 12, and 13 is assigned to a channel in the 2.4 GHZ, 5 GHZ, and 6 GHz frequency bands respectively. The PPDU 11 is assigned to a channel in the 2.4 GHz band, the PPDU 12 is assigned to a channel in the 5 GHz band, and the PPDU 13 is assigned to a channel in the 6 GHz band. Each of the PPDUs 11, 12, and 13 has a header and payload. In the embodiment, the channel width of the channel where the PPDU 13 is assigned is greater than the channel width of the channel where the PPDU 12 is assigned, and the channel width of the channel where the PPDU 12 is assigned is greater than the channel width of the channel where the PPDU 11 is assigned. As shown in FIG. 3, the PPDU 11 has a header 17 and a payload 14, the PPDU 12 has a header 18 and a payload 15, and the PPDU 13 has a header 19 and a payload 16. The headers 17, 18, and 19 include information to enable the access point 120 to interpret the received PPDUs 11, 12, and 13 properly. Each of the payloads 14, 15, and 16 comprises a plurality of aggregated MPDUs 20. The number of MPDUs 20 aggregated in the PPDU 11 does not exceed an aggregation limit N1, the number of MPDUs 20 aggregated in the PPDU 12 does not exceed an aggregation limit N2, and the number of MPDUs 20 aggregated in the PPDU 13 does not exceed an aggregation limit N3. In other words, each of the aggregation limits N1, N2, and N3 represents a maximum number of MAC Protocol Data Units (MPDUs) that can be aggregated in a physical layer protocol data unit (PPDU), and the processing circuit 112 determines the aggregation limits N1, N2, and N3 the based on the channel bandwidth of each available link. The aggregation limits N1, N2, and N3 are positive integers. The aggregation limit N1 is less than the aggregation limit N2, and the aggregation limit N2 is less than the aggregation limit N3. The 2.4 GHz band supports a smaller aggregation limit N1 due to its less channel bandwidth, the 5 GHz band supports a moderate aggregation limit N2, and the 6 GHz band supports the largest aggregation limit N3 due to its greater channel bandwidth. When the wireless communication device 110 operates in the eMLSR mode, and all the 2.4 GHz link, the 5 GHz link, and the 6 GHz link are available, the two antennas 114 rapidly switch between the three different links to simulate simultaneous multi-link communication. Within the airtime At1, both the two antennas 114 operate on the 2.4 GHz link. Within the airtime At2, both the two antennas 114 operate on the 5 GHz link. Within the airtime At3, both the two antennas 114 operate on the 6 GHz link. Since the lengths of the airtimes At1, At2, and At3 are positively related to the numbers of MPDUs 20 aggregated into the PPDUs 11, 12, and 13, the airtime At1 is less than the airtime At2, while the airtime At2 is less than the airtime At3. Therefore, a smaller aggregation limit like N1 usually results in a shorter airtime At1, while a larger aggregation limit like N3 usually results in a longer airtime At3. If all of the 2.4 GHZ, 5 GHZ, and 6 GHz links are clear links, the 6 GHz link would have the greatest performance, while the 2.4 GHz link would have the worst performance, and the 5 GHz link would have moderate performance, such that the overall network performance of the wireless communication system 100 could be improved due to the arrangement of the aggregation limits N1, N2, and N3 and corresponding airtimes At1, At2, and At3.

Since the wireless communication device 110 operates in the eMLSR mode, the airtimes At1, At2, and At3 would not overlap with each other in the time domain. The actual transmission sequence of the PPDUs 11, 12, and 13 is subject to the random nature of the backoff process defined in the Wi-Fi specification, even though FIG. 3 shows them in a specific order. The backoff mechanism in the Wi-Fi specification is a component of the Carrier Sense Multiple Access with Collision Avoidance (CSMA/CA) protocol, which governs how devices share access to the wireless medium. The backoff mechanism is used to reduce the likelihood of collisions when multiple links attempt to transmit data simultaneously using the same hardware (e.g., the antennas 114). The backoff mechanism requires links to wait a random number of slot times-chosen from a contention window-before transmitting. If a collision occurs, the contention window doubles, increasing the range of possible delays for the next attempt. This process reduces the likelihood of collisions, ensures fair access to the shared wireless medium. Consequently, while FIG. 3 presents the PPDUs 11 to 13 in a specific order for illustrative purposes, the true transmission sequence of the PPDUs 11, 12, and 13 is determined by the backoff mechanism. For example, if the backoff timer for the 6 GHz link ends first, the PPDU 13 may be sent before the PPDUs 11 and 12, despite their order in FIG. 3. Furthermore, the aggregation limits N1, N2, and N3 can be adjusted automatically based on the channel's bandwidth. Instead of using fixed ratios, these aggregation limits N1, N2, and N3 can be changed depending on how much channel bandwidth is available. For example, N3 might be about 1.5 to 3 times larger than N2, and N2 might be 2 to 10 times larger than N1, but the exact numbers depend on the channel's bandwidth. This makes the system more efficient under different network conditions.

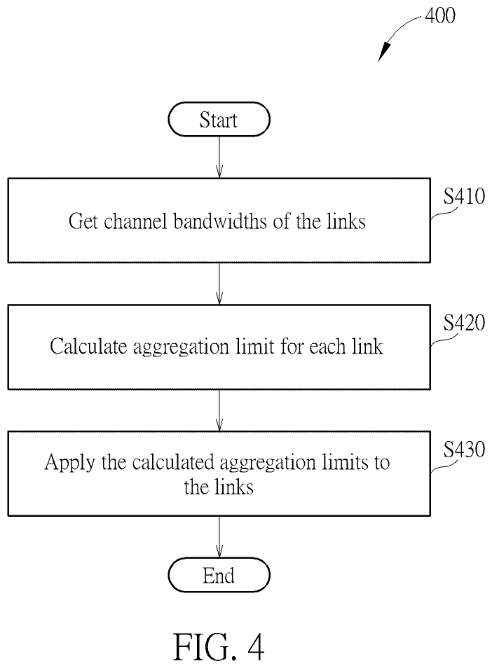

FIG. 4 is a flowchart of a method 400 executed by the processing circuit 112 of the wireless communication device 110 shown in FIG. 1 when the wireless communication device 110 operates in the enhanced Multi-Link Single Radio (eMLSR) mode. The method 400 is configured to determine and apply the aggregation limits N1, N2, and N3. The method 400 includes three steps S410, S420, and S430. In step S410, the processing circuit 112 retrieves the channel bandwidth information for all active links. In step S420, the processing circuit 112 calculates the aggregation limit (e.g., N1, N2, or N3) for each available link. In step S430, the processing circuit 112 applies the calculated aggregation limits (e.g., N1, N2, or N3) to the corresponding available links.

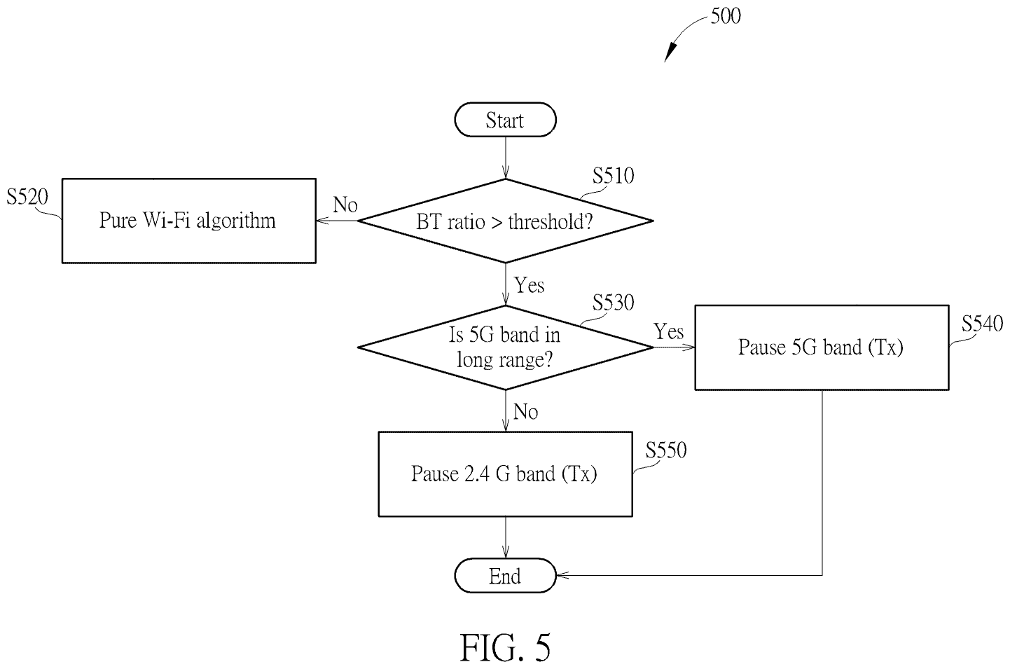

FIG. 5 is a flowchart of a method 500 executed by the processing circuit of the wireless communication device shown in FIG. 1 when the wireless communication device operates in a coexistence environment. In the coexistence environment, the wireless communication device 110 may use at least two of the 2.4 GHZ, 5 GHZ, and 6 GHz frequency bands. The method 500 is intended to address the challenges posed by Bluetooth interference on Wi-Fi performance, especially in Multi-Link Operation (MLO) mode within the 2.4 GHz band. The 2.4 GHz band has a frequency range shared by both Wi-Fi and Bluetooth technologies. The method 500 includes five steps S510 to S550. In step S510, the processing circuit 112 evaluates the current Bluetooth activity on the 2.4 GHz band by calculating the Bluetooth activity ratio, commonly referred to as the BT ratio. The BT ratio indicates the proportion of time that Bluetooth activity uses the 2.4 GHz band. If the BT ratio does not exceed a predetermined threshold, it means that Bluetooth activity is not significant enough to interfere with Wi-Fi operation. Therefore, the wireless communication device 110 maintains data transmission on the 2.4 GHz band and proceeds to step S520. If the BT ratio exceeds the predetermined threshold, the processing circuit 112 executes step S530. The predetermined threshold, for instance, can be equal to 10%. However, the processing circuit 112 can adjust the BT ratio depending on the situation. In step S520, the processing circuit 112 directs the transmitter (Tx) of the wireless communication device 110 to transmit data on the 2.4 GHz band solely, thus avoiding using the 5 GHz or 6 GHz bands. In step S530, the processing circuit 112 assesses the feasibility of using the 5 GHz or 6 GHz bands based on the distance to the AP 120. By analyzing signal strength (e.g., RSSI) and signal quality (e.g., SNR), the processing circuit 112 determines whether the 5 GHz or 6 GHz links can support effective data transfer at that distance. If the 5 GHz or 6 GHz bands are unavailable due to weak signal strength at that distance, the method 500 proceeds to step S540. Alternatively, if the 5 GHz or 6 GHz bands are available at that distance, the method 500 transitions to step S550. In step S540, the processing circuit 112 pauses data transmission on the 5 GHz and 6 GHz bands and uses the 2.4 GHz band for wider signal coverage. In step S550, the processing circuit 112 pauses data transmission on the 2.4 GHz band and uses the 5 GHz and 6 GHz bands for better performance.

In both steps S540 and S550, the processing circuit 112 may send a Power Save Mode bit (PSB) to the AP 120 to indicate that a certain frequency band is temporarily in a sleep mode and temporarily unavailable for receiving data. In step S540, the processing circuit 112 sends the PSB to the AP 120 to inform the PSB to stop using the 5 GHz or 6 GHz bands so as to direct the AP 120 to use the 2.4 GHz band for wider signal coverage. In contrast, in step S550, the processing circuit 112 sends the PSB to the AP 120 to inform the PSB to stop using the 2.4 GHz band and to instruct the AP 120 to use the 5 GHz or 6 GHz bands for better performance.

In summary, this invention introduces an intelligent traffic management system for Wi-Fi 7 (IEEE 802.11be) Multi-Link Operation (MLO) mode. This system enables simultaneous communication across multiple frequency bands. The wireless communication device dynamically adjusts data transmission by intelligently selecting and managing network links based on real-time performance indicators such as interference levels, signal strength, latency, and throughput. Furthermore, the present invention provides an adaptive approach for link selection and data aggregation. By analyzing the channel bandwidths of the different links, the system can adaptively adjust corresponding aggregation limits for generating PPDUs to improve overall network performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication device comprising:
at least one antenna configured to transmit and receive radio frequency signals; and
a processing circuit coupled to the at least one antenna, the processing circuit configured to:
determine at least one available link between the wireless communication device and an access point across different frequency bands in an enhanced Multi-Link Single Radio (eMLSR) mode;
determine, for each of the at least one available link, an aggregation limit representing a maximum number of MAC Protocol Data Units (MPDUs) that can be aggregated in a physical layer protocol data unit (PPDU) structure based on a channel bandwidth of each available link, such that an available link with a smaller channel bandwidth has a smaller aggregation limit, and an available link with a greater channel bandwidth has a larger aggregation limit;
select a link from the at least one available link; and
transmit data to the access point via the at least one antenna through the selected link by sending a PPDU having a number of aggregated MPDUs not exceeding the aggregation limit determined for the selected link.

2. The wireless communication device of claim 1, wherein the different frequency bands comprise at least two of 2.4 GHz, 5 GHZ, and 6 GHz.

3. The wireless communication device of claim 1, wherein the processing circuit is further configured to:
monitor radio frequency (RF) characteristics of each of the at least one available link, wherein the RF characteristics comprise at least one of signal strength and signal quality.

4. The wireless communication device of claim 3, wherein the processing circuit selects the selected link from the at least one available link based on the monitored RF characteristics.

5. The wireless communication device of claim 1, wherein the processing circuit is further configured to:
monitor interference on each of the at least one available link.

6. The wireless communication device of claim 5, wherein the interference comprises at least one of Overlapping Basic Service Set (OBSS) interference, Bluetooth interference, and noise.

7. The wireless communication device of claim 5, wherein the processing circuit selects the selected link from the at least one available link based on the monitored interference.

8. The wireless communication device of claim 1, wherein the wireless communication device operates in an enhanced Multi-Link Single Radio (eMLSR) mode.

9. The wireless communication device of claim 8, wherein, in the Enhanced Multi-Link Single Radio (eMLSR) mode, the processing circuit is further configured to dynamically adjust the aggregation limit for each available link based on channel bandwidths of the available links, such that a link with a smaller channel bandwidth is restricted to a smaller number of aggregated MPDUs to reduce its airtime occupancy, thereby increasing overall throughput of the wireless communication device in the MLO mode.

10. The wireless communication device of claim 1, wherein the processing circuit is further configured to monitor Bluetooth activity of the wireless communication device.

11. The wireless communication device of claim 10, wherein the processing circuit selects the selected link from the at least one available link based on based on the monitored Bluetooth activity.

12. The wireless communication device of claim 1, wherein the processing circuit is further configured to send a Power Save Mode bit (PSB) to the access point to indicate that a specific band of the different frequency bands is in a sleep mode and temporarily unavailable for receiving data.

13. A method for wireless communication, the method comprising:
determining, by a wireless communication device, at least one available link between the wireless communication device and an access point across different frequency bands in a multi-link operation (MLO) mode;
determining, by the wireless communication device, for each of the at least one available link, an aggregation limit representing a maximum number of MAC Protocol Data Units (MPDUs) that can be aggregated in a physical layer protocol data unit (PPDU) structure based on a channel bandwidth of each available link, such that an available link with a smaller channel bandwidth has a smaller aggregation limit, and an available link with a greater channel bandwidth has a greater aggregation limit;
selecting, by the wireless communication device, a link from the at least one available link; and
transmitting, by the wireless communication device, data to the access point via at least one antenna of the wireless communication device through the selected link by sending a PPDU having a number of aggregated MPDUs not exceeding the aggregation limit determined for the selected link.

14. The method of claim 13, wherein the different frequency bands comprise at least two of 2.4 GHz, 5 GHZ, and 6 GHz.

15. The method of claim 13, further comprising:
monitoring, by the wireless communication device, radio frequency (RF) characteristics of each of the at least one available link, wherein the RF characteristics comprise at least one of signal strength and signal quality.

16. The method of claim 15, wherein selecting the link from the at least one available link is further based on the monitored RF characteristics.

17. The method of claim 13, further comprising:
monitoring, by the wireless communication device, interference on each of the at least one available link.

18. The method of claim 17, wherein selecting the link from the at least one available link is further based on the monitored interference.

19. The method of claim 17, wherein the interference comprises at least one of Overlapping Basic Service Set (OBSS) interference, Bluetooth interference, and noise.
